(19) United States
(12) Patent Application Publication
(10) Pub. No.: US 2022/0186342 A1
(43) Pub. Date: Jun. 16, 2022

(54) NON-MAGNETIC MEMBER AND METHOD FOR PRODUCING THE NON-MAGNETIC MEMBER

(71) Applicant: KABUSHIKI KAISHA TOYOTA JIDOSHOKKI, Kariya-shi (JP)

(72) Inventors: Junya SUZUKI, Aichi-ken (JP); Hidetaka HAYASHI, Aichi-ken (JP); Tetsuya MITSUOKA, Aichi-ken (JP); Tadahiko FURUTA, Aichi-ken (JP)

(73) Assignee: KABUSHIKI KAISHA TOYOTA JIDOSHOKKI, Kariya-shi (JP)

(21) Appl. No.: 17/544,200

(22) Filed: Dec. 7, 2021

(30) Foreign Application Priority Data
Dec. 11, 2020 (JP) 2020-206145
Nov. 24, 2021 (JP) 2021-189787

(51) Int. Cl. C22C 14/00; B22F 3/10

(52) U.S. Cl. CPC C22C 14/00; B22F 2301/205; B22F 3/10

(57) ABSTRACT

A non-magnetic member, which is used in an alternating magnetic field, comprises a titanium alloy comprising an alpha stabilizer in which an aluminum equivalent is 5.5-11.0 by mass fraction to the total mass of the titanium alloy and a beta stabilizer in which a molybdenum equivalent is 6.0-17.0 by mass fraction to the total mass of the titanium alloy. The beta stabilizer comprises iron and manganese.

### CROSS-REFERENCE TO RELATED APPLICATION

This application claims priority to Japanese Patent Application No. 2020-206145 filed on Dec. 11, 2020 and No. 2021-189787 filed on Nov. 24, 2021, the entire disclosure of which is incorporated herein by reference.

The present disclosure relates to a non-magnetic member used in an alternating magnetic field and a method for producing the non-magnetic member.

### BACKGROUND ART

Devices using electromagnetism (simply referred to as electromagnetic devices) include various devices, such as motors, generators, and actuators, which are often used in an alternating field. For energy saving, such electromagnetic devices are required to reduce power loss in the high frequency range when the electromagnetic devices are used in an alternating magnetic field. Particularly, devices such as (ultra) high-speed motors are highly required to reduce eddy-current loss, which increases with the square of rotation frequency (frequency of an alternating magnetic field). In order to reduce the eddy current, which is generated in a direction perpendicular to the alternating magnetic field, for example, a rotor core and a stator core of a motor are often formed of laminated magnetic steel sheets with insulation layer.

However, it is difficult for some of members used in the alternating magnetic field (i.e., a member for electromagnetic field) to have such a configuration. Accordingly, such a member for electromagnetic field needs to employ a material with high electric resistivity (i.e., specific electrical resistance) so as to reduce eddy-current loss.

The member for electromagnetic field disposed in a magnetic circuit does not necessarily employ a magnetic material, and may employ a non-magnetic material. Further, the member for electromagnetic field may need to satisfy requirements for predetermined mechanical properties (e.g., stiffness, strength, ductility) as well as electrical properties (e.g. specific electrical resistance) and magnetic properties (e.g. magnetic permeability). Such a member for electromagnetic field is mentioned in Japanese Patent Application Publication No. 2001-339886, No. 2008-029153, No. 2020-043746, No. H05-5142, Japanese Patent No. 3712614 (WO2000/005425), Japanese Patent Application Publication No. 2005-320618, No. 2005-524774 (WO2003/095690), and U.S. Pat. No. 4,731,115.

Japanese Patent Application Publication No. 2001-339886 and No. 2008-029153 mention a protection tube (a protection sleeve) made of carbon fiber reinforced plastic (CFRP) as an example of a member for electromagnetic field (i.e., a non-magnetic member) consisting of non-magnetic material. The protection tube is fitted onto a cylindrical permanent magnet that is disposed to surround a rotor shaft of a motor (a rotary shaft). The protection tube prevents damage to the permanent magnet, which may be caused by a centrifugal force generated during high-speed rotation of the motor. However, the protection tube made of CFRP may not have sufficient mechanical properties against a further increase in the rotation frequency of the motor.

Japanese Patent Application Publication No. 2020-043746 mentions a non-magnetic member consisting of a titanium-based composite material. The titanium-based composite material is formed by dispersing reinforcing particles, which are consisting of TiCy (0<y<1) in which part of Carbon is missing, into a matrix comprising Ti-6%/Al -4% V. This non-magnetic member has relatively a high specific electrical resistance, a high strength, and a high stiffness.

Japanese Patent Application Publication No. H05-5142, Japanese Patent No. 3712614, Japanese Patent Application Publication No. 2005-320618, No. 2005-524774, and U.S. Pat. No. 4,731,115 mention a titanium alloy or a titanium-based composite material, but not specifically mention a member for electromagnetic field and the specific electrical resistance of the member for electromagnetic field.

The present disclosure, which has been made in light of such circumstances, is directed to providing a non-magnetic member comprising a titanium alloy different from conventional titanium alloys and a method for producing the non-magnetic member.

### SUMMARY

In accordance with an aspect of the present disclosure, there is provided a non-magnetic member, which is used in an alternating magnetic field, comprises a titanium alloy comprising an alpha stabilizer in which an aluminum equivalent is 5.5-11.0 by mass fraction to the total mass of the titanium alloy and a beta stabilizer in which a molybdenum equivalent is 6.0-17.0 by mass fraction to the total mass of the titanium alloy. The beta stabilizer comprises iron and manganese.

In accordance with another aspect of the present disclosure, there is provided a method for producing the non-magnetic member. The method comprises: sintering a powder to produce a sintered body; and forming the sintered body into a shape desired for the non-magnetic member. After the forming step, the titanium alloy is produced without solution treatment.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure together with objects and advantages thereof, may best be understood by reference to the following description of the embodiment together with the accompanying drawings in which:

FIG. 1A is an image (SEM image) of the structure of a titanium alloy of sample 2;

FIG. 1B is an enlarged image (SEM image) of the structure of the titanium alloy of sample 2;

FIG. 2 is an image (SEM image) of the structure of a titanium alloy of sample 3; and

FIG. 3 is an explanatory diagram depicting a method for measuring a specific electrical resistance.

### DETAILED DESCRIPTION OF THE EMBODIMENTS

In the course of studies to solve the above-described problems, the present inventors found a titanium alloy that has a composition different from conventional compositions and has relatively a high specific electrical resistance and a high strength. The present inventors have developed this finding and have achieved the present invention described below.

### Non-Magnetic Member

(1) A non-magnetic member according to an embodiment of the present disclosure is used in an alternating magnetic field and comprises a titanium alloy comprising an alpha stabilizer in which an aluminum equivalent (Al equivalent) is 5.5-11.0 by mass fraction to the total mass of the titanium alloy and a beta stabilizer in which a molybdenum equivalent (Mo equivalent) is 6.0-17.0 by mass fraction to the total mass of the titanium alloy, wherein the beta stabilizer comprises iron (Fe) and manganese (Mn).
(2) The non-magnetic member (i.e., a member for electromagnetic field) according to an embodiment of the present disclosure comprises a titanium alloy that has relatively a high specific electrical resistance and a high strength compared with the conventional titanium alloy. This allows reduction of eddy-current loss generated in the non-magnetic member even if the non-magnetic member is used in an alternating magnetic field with high-frequency range (for example, high-rotative speed range). This further allows the non-magnetic member to have a thin wall, light weight, and a small size although the non-magnetic member may be subjected to relatively large forces, such as a centrifugal force and an inertial force, which may be generated by fast motions (e.g., rotation, reciprocating motion).

The reason why the titanium alloy according to the embodiment of the present disclosure has such a high specific electrical resistance and a high strength is not altogether clear. However, it is currently considered that combination of the alpha stabilizer with high aluminum equivalent and the beta stabilizer with high molybdenum equivalent provides such a titanium alloy having a high specific electrical resistance and a high strength. Particularly, iron (Fe), a magnetic element, dissolved in titanium (Ti) improves the specific electrical resistance of the non-magnetic titanium alloy. Further, on the condition that the Al equivalent and Mo equivalent of the titanium alloy are within the predetermined range, it is considered that the presence of manganese (Mn) notably improves the strength of the titanium alloy.

### Titanium Alloy

### (1) Composition

The titanium alloy may comprise alpha stabilizers in which an aluminum equivalent is 5.5-11.0, preferably 6.0-10.0, more preferably 7.0-9.5, most preferably 8.0-9.0 (further most preferably, within a range narrower than 8.0-9.0) and beta stabilizers in which a molybdenum equivalent is 6.0-17.0, preferably 6.5-15.0, more preferably 7.0-12.0, most preferably 8.0-11.5. The titanium alloy has insufficient specific electrical resistance if the aluminum equivalent is under this specified amount, but has a decrease in extension when the aluminum equivalent is over the specified amount. The titanium alloy has insufficient strength if the molybdenum equivalent is under this specified amount, but has a decrease in extension if the molybdenum equivalent is over the specified amount.

The aluminum equivalent ([Al]eq) and the molybdenum equivalent ([Mo]eq) are calculated as below (reference: Journal of Japan Institute of Light Metals, Vol. 55, No. 2 (2005), pp. 97-102).

[Al]eq=[Al]+[Zr]/6+[Sn]/3+10[O]+16.4[N]+11.7[C]

[Mo]eq=[Mo]+[Ta]/5+[Nb]/3.5+[W]/2.5+[V]/1.5+1.25[Cr]+1.25[Ni]+1.7[Mn]+1.7[Co]+2.5[Fe]

Unless otherwise specified, however, the Al equivalent in the present disclosure is calculated by [Al]eq=[Al]+[Zr]/6+[Sn]/3, only using Al, Zr, and Sn that are major elements of the alpha stabilizers.

In the present disclosure, composition ratio (concentration) is represented by mass fraction (percentage by mass) using “%”. The elements with brackets in the above-mentioned formula indicate the mass fraction (%) of each alloy element to the total mass of the titanium alloy. When the titanium-based composite material having reinforcing particles (e.g., TiC, TiB) dispersed in the titanium alloy (matrix) is used, the aluminum equivalent and molybdenum equivalent of the matrix are determined as a mass fraction of the reinforcing particles to the total mass of the matrix.

The alpha stabilizers may comprise any neutral elements, such as Zr and Sn, other than Al, for example. Al, which is a typical alpha stabilizer, may account for 7-10%, preferably 8-9% of the whole titanium alloy (100 mass %), for example.

The beta stabilizers may comprise Mo, vanadium (V), Mn, and Fe, for example. Mo, which is a typical beta stabilizer, may account for 1.0-5.0%, preferably 1.5-4.0% of the whole titanium alloy. Further, V may account for 4-8%, preferably 5-7% of the whole titanium alloy.

Further, the titanium alloy may comprise Fe for improving the specific electrical resistance and Mn for increasing the strength. Of the whole titanium alloy, Fe may account for 0.5-3.5%, preferably, 0.9-3%, more preferably 1.0-2.5%, and Mn may account for 0.2-3.0%, preferably, 0.4-2.5%, more preferably 0.5-1.5% by mass fraction.

Further, the titanium alloy may comprise sulfur (S) for increasing the machinability, and sulfur may account for 0.1-1.0%, preferably 0.2-0.7%, more preferably 0.3-0.5% of the whole titanium alloy. It is not essential that the titanium alloy comprises sulfur (S), but sulfur may increase machinability of the titanium alloy. However, if the titanium alloy comprises more than the specified amount of sulfur, the titanium alloy may be embrittled.

The titanium alloy contains impurities (e.g., oxygen (O), nitrogen (N)), which are technically and economically inevitable. For example, oxygen (O) may account for approximately 0.1-0.7%, preferably 0.2-0.5% of the whole titanium alloy.

### (2) Structure

The metal structure of the titanium alloy (simply referred to as a structure) may vary through the production process or heating treatment. For example, the structure differs depending on its material, such as a cast material or a sintered material. Further, when the sintered material is employed as a material of the titanium alloy, the structure differs depending on process conditions, such as the presence of heat treatment and heat treatment conditions. The titanium alloy according to the embodiment of the present disclosure has a sufficiently large aluminum equivalent and molybdenum equivalent, so that this titanium alloy is likely to become a metal structure in which α-phase and β-phase are mixed although a specific structure is not described here.

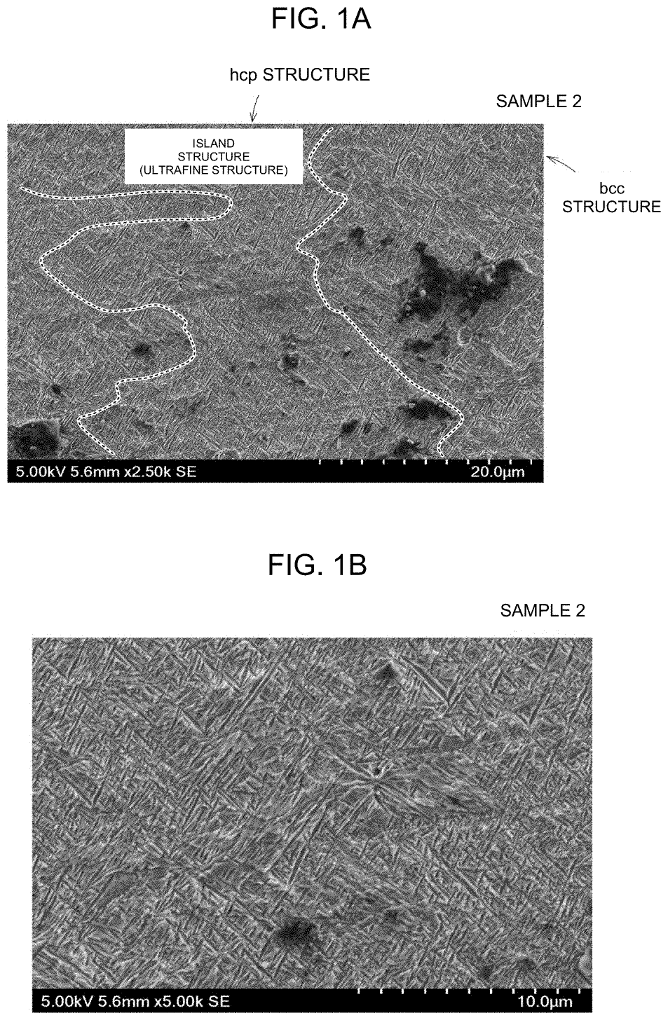

As an example, the titanium alloy consisting of a sintered material may have a complex structure in which hexagonal close-packed lattice structures (i.e., hcp structures) are distributed like islands in a body centered cubic lattice structure (i.e., bcc structure) (see FIG. 1A). The bcc structure mainly comprises β-phase, and the hcp structures mainly comprise α-phase. More specifically, the bcc structure mainly comprises Ti as a base element and at least one of the beta stabilizers (such as Mo, Fe, and V). The hcp structures mainly comprise the base element Ti and at least one of the alpha stabilizers (such as Al). The bcc structure may comprise at least one of the alpha stabilizers. As well, the hcp structures may comprise at least one of the beta stabilizers.

The hcp structures account for 30-70 vol %, preferably, 37-67 vol %, more preferably 43-60 vol % of the whole complex structure, for example. For example, each of the hcp structures is an aggregate of ultrafine structures in the form of acicular or fine granular particles. A maximum length of each of the ultrafine structures is 2 μm or less, preferably 1 μm or less. An aspect ratio (maximum length/minimum length) of each of the ultrafine structures is 3-20, preferably 5-10, for example. The volume fraction, size, and aspect ratio of each structure (phase) are determined by analyzing 2D optical microscope images with “ImageJ”, an open-source image processing program.

The conventional titanium alloy does not have the above-described complex structure. However, the relationship between the structure of the titanium alloy and the characteristic properties of the titanium alloy (e.g., specific electrical resistance, strength) is not currently clear.

(3) Characteristic properties

The titanium alloy according to embodiment of the present disclosure has excellent electrical and mechanical properties. For example, the titanium alloy exhibits a specific electrical resistance of 2.0-5.0 μΩm, preferably 2.1-4.0 μΩm, more preferably 2.2-3.0 μΩm. This specific electrical resistance is much larger than that of pure titanium alloy (approximately 0.4 μΩm) or that of a typical titanium alloy (Ti-6Al-4V) (approximately 1.7 μΩm). Unless otherwise specified, the specific electrical resistance in this specification is calculated by measuring the specific electrical resistance of samples (bulk material) in a predetermined size with four-terminal DC sensing (see FIG. 3).

For example, the titanium alloy according to the embodiment of the present disclosure has high strengths such as 1200-1700 Mpa, preferably 1250-1650 MPa, more preferably 1350-1550 MPa of a tensile strength (a rupture strength) and 1150-1600 MPa, preferably 1200-1500 MPa of a 0.2% proof stress. Further, this titanium alloy has a high stiffness such as 115-135 GPa, preferably 120-130 GPa of Young's modulus.

This titanium alloy further has approximately 0.2-2.0%, preferably approximately 0.4-1.5% of an elongation, which allows plastic forming of the non-magnetic member.

Production method

The present invention is applicable to a method for producing the above-described non-magnetic member or the titanium alloy. For example, when the titanium alloy consists of a sintered material, the non-magnetic member comprising the titanium alloy is produced through a step for sintering a powder to produce a sintered body and a step for forming the sintered body into a shape desired for the non-magnetic member. Further, the titanium alloy consisting of the sintered material may exhibit an excellent high specific electrical resistance and a high strength without necessarily heat treatment (e.g., solution treatment, aging treatment) after the forming step. The material of the titanium alloy according to the embodiment of the present disclosure is not limited to the sintered material, but may be a cast material.

The titanium alloy (non-magnetic member) according to the embodiment of the present disclosure may be produced by a method, such as sintering, melting and casting, or a (powder) additive manufacturing (3D printing). As an example, sintering of the titanium alloy will be described as below.

Sintering is a method for heating a powder compact to produce a sintered body. When the compact or the sintered body has a shape similar to that of the non-magnetic member (i.e., near net shape), it is not necessary to perform the post process for machining the sintered body. However, the sintered body may be processed by cold or hot plastic forming, such as forging or press working.

### (1) Powder

Usually, a mixed powder composed of various types of raw material powders is compacted and sintered to produce the titanium alloy. The raw material powders comprise an alloy powder or a compound powder, other than an elemental powder. The elemental powder includes, for example, a Ti powder (pure titanium powder). The alloy powder includes, for example, Al—V powder, Ti—Al powder, Fe—Mo powder (ferromolybdenum powder). The compound powder includes, for example, Mn—S powder (manganese sulfide powder) and Fe—Mn (ferromanganese powder). Even the same type of powder having the same alloying element has various composition ratios. Suitable raw material powders may be selected depending on the desired composition. In any case, using an alloy powder or a compound powder rather than using an elemental powder allows reduction of the raw material cost, and uniformity and stabilization of the structure.

The average particle diameter of each of the powders is, for example, 1-20 μm, preferably, 3-15 μm in median size (D50). The mixed powder is prepared by using a V-type mixer, a ball mill, or a vibration mill in a mixing step.

(2) Compacting step

The mixed powder is compacted into a compact having a desired shape by molding, Cold Isostatic Pressing (CIP), or Rubber Isostatic Pressing (RIP). The compact may have a shape similar to the member finally obtained (i.e., non-magnetic member). Alternatively, the compact may be a billet (semi-finished) when forming step is held after the sintering step. Compacting pressure may be adjusted as necessary, but may be 200-600 MPa, preferably 300-400 MPa, for example.

(3) Sintering step

The compact is heated under vacuum or in inert gas to produce a sintered body. The sintering temperature may be 1150-1400° C., preferably 1200-1350° C., for example. The sintering time may be 3-25 hours, preferably 10-20 hours, for example. The appropriate sintering temperature and time efficiently produce a titanium alloy having properties at high level. The above-described compacting step and sintering step may be performed at the same time by Hot Isostatic Pressing (HIP).

(4) Cooling step

The sintered body may be cooled by furnace cooling or forced cooling (by introducing inert gas or the like) at 0.1-10° C./s. The structure and properties of the titanium alloy may be adjusted by control of the cooling velocity.

(5) Forming step

The sintered body may be used as the non-magnetic member without any processing, or may be processed by plastic forming, cutting machining, or the like. The plastic forming may be held by cold-plastic forming or hot-plastic forming. Performing hot-plastic forming reduces cracks in the body and improves the production yield of the non-magnetic member. Cooling after the hot-plastic forming may be furnace cooling, but air cooling is also sufficient for this cooling.

The titanium alloy according to the embodiment of the present disclosure, which is produced as described above, has a desired structure and properties without heat treatment, such as solution treatment or aging treatment. This non-heat-treatable titanium alloy contributes reduction of manufacturing cost of the non-magnetic member.

### Non-Magnetic Member and Motorized Equipment

The non-magnetic member according to the embodiment of the present disclosure is a suitable member for electromagnetic field used in the alternating magnetic field because of its relatively high specific electrical resistance, high strength, and low magnetic permeability compared with the conventional non-magnetic member. Regardless of its use, for example, this non-magnetic member can be used as a protection member (e.g., protection tube, protection case) for protecting permanent magnets (i.e., a field source) assembled in an electric motor device (e.g., electromagnetic device) (see Japanese Patent Application Publication No. 2020-043746). A high-speed rotating centrifugal compressor is one example of such an electric motor device. This compressor is used as an air compressor for a supercharger of an engine or a fuel cell, for example.

### EXAMPLE

Various samples of a sintered titanium alloy having a different element composition were prepared to evaluate their electrical property (specific electrical resistance) and mechanical properties (tensile strength, 0.2% proof stress, Young's modulus, elongation). The invention will be described in more detail with reference to the following example.

### Preparation of Samples

(1) Raw material powder

Ti powder was prepared by sieving and classifying a dehydrogenated powder, which is manufactured by TOHO TECHNICAL SERVICE CO., LTD and commonly available, with a sieve (#350, average particle diameter: 75 μm).

The alloy powder as an alloy element source comprises one or a plurality of the following powders:

(a) Al-40% V powder (average particle diameter: 9 μm, manufactured by KINSEI MATEC CO., LTD),

(b) Ti-36% Al powder (average particle diameter: 9 μm, manufactured by Daido Steel Co., Ltd),

(c) Fe-60% Mo powder (average particle diameter: 45 μm, manufactured by TAIYO KOKO CO., LTD.), and

(d) MnS powder (average particle diameter: 9 μm, manufactured by Fukuda Metal Foil & Powder Co., Ltd.).

(e) Fe-78% Mn powder (average particle diameter: 10 μm, manufactured by Fukuda Metal Foil & Powder Co., Ltd.)

Unless otherwise specified, in the example, the composition ratio is represented by mass fraction (percentage by mass) to the total mass of the raw material powder or mixed powder using “%”. The average particle diameter of each powder was measured by a laser diffraction particle size analyzer (MT3300EX, manufactured by Nikkiso Co., Ltd.). Each powder may slightly contain oxygen (impurity) ineluctably adsorbed or bound onto the particle surface.

(2) Mixing step

The raw material powders were weighed and blended such that each sample (excluding samples C4, C5) has a gross composition (aluminum equivalent and molybdenum equivalent) as shown in Table 1. The blended powder was mixed by a V-type mixer for one hour to produce a mixed powder for each sample.

(3) Compacting step

Each blended powder was put in a polyvinyl chloride (PVC) tube and compacted by CIP into a compact having a round-rod shape (approximately φ16 mm×150 mm). The compacting pressure were 4 t/cm² (392 MPa).

(4) Sintering step

Each compact was sintered under vacuum (1×10⁻⁵ Torr) at 1300° C. for 16 hours to produce a sintered body. The rate of temperature increase to the sintering temperature was about 5° C./min, and the cooling velocity after sintering was 10° C./s.

(5) Forming step

The sintered body of each sample was hot-processed by forging in an atmosphere. The heating temperature was 1200° C. and the processing rate was 56%. The processing rate was calculated by using reduction rate of cross-section area (Aw/Ao). Aw is a cross-section area of each sample after hot-processing is performed, and Ao is a cross-section area of each sample before hot-processing is performed.

The sintered body hot processed was cooled in the atmosphere to decrease the temperature of the sintered body without heating after the cooling. In such away, billets were prepared as test materials for measurement and observation.

(6) Comparative example (cast material)

As comparative example, samples C4 and C5, shown in Table 1, were made of a commercially available cast material (manufactured by Daido Steel Co., Ltd) as test materials.

### Measurement

(1) Electrical properties (specific electrical resistance)

The specific electrical resistance of each sample was measured as shown in FIG. 3. Specifically, for measurement, electrodes were formed in a rectangular column (3.014 mm (t)×3.014 mm (w)×20 mm) made of each test material as below. The center part of each rectangular column (distance between voltage electrodes (L): 10 mm) was covered by a masking tape. The column was wound with lead terminals (silver lead in φ0.20 mm) at four positions such as ends of the center part and outside of each of the ends as shown in FIG. 3. The portions of the column wound with the lead terminals and opposite end surfaces of the column were coated with silver paste (“DOTITE D-550” manufactured by FUJIKURA KASEI CO., LTD.). The coated rectangular columns were heated and dried in the atmosphere at 100° C. for 12 hours. In this way, test specimens having current electrodes and voltage electrodes were prepared.

The specific electrical resistance (electric resistivity) of each sample was calculated by the formula (1) shown in FIG. 3 based on a voltage value (V), a current value (I), and the cross-section shape (S=t×w) of each test specimen (rectangular column). The voltage value (V) and the current value (I) were measured with four-terminal DC sensing in room temperature. Table 1 shows the specific electrical resistance (measurement value) of each sample obtained.

(2) Mechanical properties (Young's modulus, tensile strength, elongation)

The round-rod test specimen (parallel diameter: φ2.4 mm, gauge length: 14 mm) was made of each test material, and tensile tested with a testing machine, AUTOGRAPH AG-1 50kN, manufactured by SHIMADZU CORPORATION.

The tensile testing was conducted at a strain rate of 5×10⁻⁴/s in the atmosphere at room temperature. The tensile testing provided a load-stroke diagram by using a load cell and a video extensometer. The mechanical properties of each sample were evaluated based on the stress-strain relationship calculated by using the load-stroke diagram (see JIS Z 2241:2011). Table 1 shows the mechanical properties found in the test. The tensile strength was calculated based on the rupture load and the initial shape of each test specimen. The elongation is strain of a test specimen by rupture.

### Observation

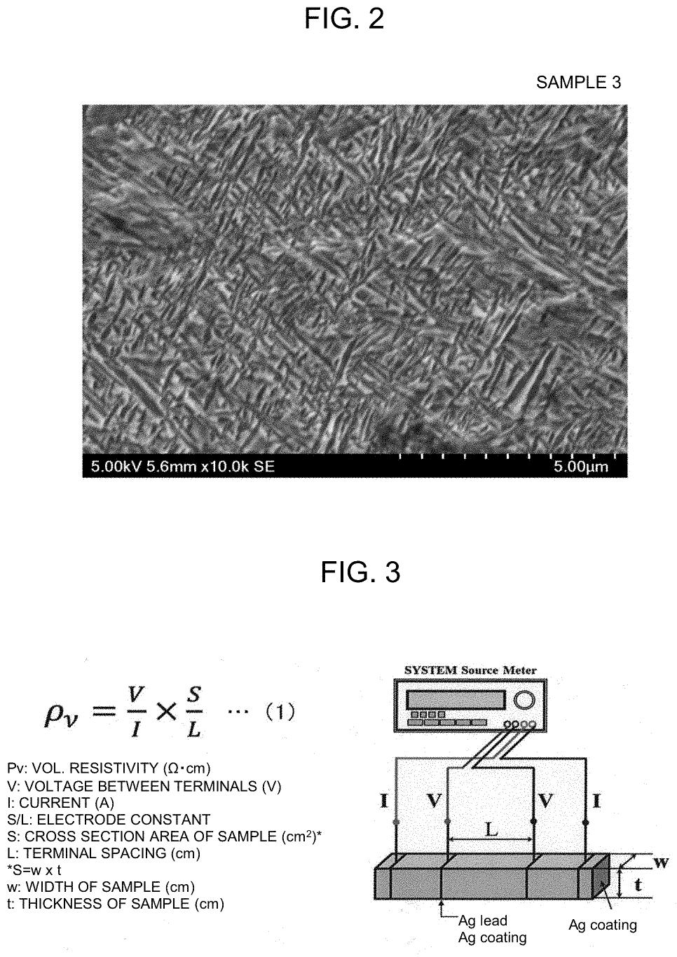

(1) The structure of each test material before tensile tested was observed with a Scanning Electron Microscope (SEM). FIGS. 1A, 1B show observation images (SEM images) of sample 2 as one example. FIG. 2 shows an SEM image of sample 3. Both of FIGS. 1B and 2 show an enlarged island structure.
(2) The SEM images of the structure of each test material before tensile tested were analyzed with ImageJ to determine an abundance ratio of island structure of each sample. Table 1 shows the abundance ratio of island structure found in the test.
(3) X-Ray diffraction

The structure before tensile tested was examined by the X-ray diffractometry (XRD using CuKα). This analysis found that the island structure was a hexagonal close-packed lattice structure, and a base structure surrounding the island structure was a body centered cubic lattice structure.

### Evaluation

(1) Characteristic properties

As is clear form Table 1, the titanium alloy of each of samples 1-5, having Al equivalent and Mo equivalent within the predetermined range and containing Fe and Mn, has a high specific electrical resistance and a high strength compared with samples C1-C5.

Further, sample 5, which is the titanium alloy without containing S, has a high ductility in addition to a high specific electrical resistance and a high strength compared with samples C1-C5. Specifically, the titanium alloy of sample 5 exhibits a tensile strength of 1600 Mpa or more and an elongation of 1% or more. That is, the titanium alloy of sample 5 has a tensile strength and an elongation, which generally conflict with or incompatible with each other, both at high level.

In contrast, samples C1, C2 having relatively small Mo equivalent have an insufficient strength compared to other samples. In samples C4, C5 having small Al equivalent, a specific electrical resistance is insufficient at least. Further, sample C3 has Al equivalent and Mo equivalent within the predetermined range and has a high specific electrical resistance compared with other samples, but has an insufficient strength (particularly, 0.2% proof stress is insufficient) because C3 does not contain Mn.

### (2) Structure

As is clear from FIG. 1A and Table 1, samples 1-5 have a complex structure in which many island hcp structures (i.e., island structures) are surrounded by a bcc structure. Further, as is clear from FIGS. 1B and 2, each of the island structures consists of an aggregate of ultrafine structures/microstructures in the form of acicular or fiber particles. Further, it was found from the SEM images that a maximum length of each of the ultrafine structures/microstructures is 2 μm or less, and an aspect ratio of each of the ultrafine structures/microstructures is 5 or more.

The titanium alloy of each of samples 1-4 was actually processed by machining. This actual machining found that the titanium alloy of each of samples 1-4 has better machinability than that of each of samples C1-C5.

From the above-described results, it was found that the titanium alloy having Al equivalent and Mo equivalent within the predetermined range and containing Fe and Mn has a high specific electrical resistance and a high strength compared with the conventional titanium alloy and is suitable for a member for electromagnetic field (i.e., the non-magnetic member). The results also found that this titanium alloy has a differential structure in which hcp structures (i.e., island structures), which are aggregates of microstructures, are distributed in a bcc structure.

### Others

(1) The alpha stabilizer in this specification is an alloy element that raises the allotropic transformation temperature (approximately 885° C.) of pure titanium to increase the a-phase region. The beta stabilizer in this specification is an alloy element that lowers the allotropic transformation temperature of pure titanium to increase the β-phase region. In other words, the alpha stabilizer is an element that is used in the calculation formula of the aluminum equivalent, and the beta stabilizer is an element that is used in the calculation formula of the molybdenum equivalent. In this specification, a neutral alloy element (an isomorphous element), such as tin (Sn) or zirconium (Zr), is treated as an alpha stabilizer or a beta stabilizer as long as it is an alloy element affecting the allotropic transformation temperature or the equivalents. The titanium alloy according to the embodiment of the present disclosure may further comprise a neutral element that does not affect the allotropic transformation temperature or the equivalents (an alloy element that does not affect the allotropic transformation temperature).

The non-magnetism (magnetic permeability) in this specification may be at any degree within the range in which short-circuit is not caused in the magnetic circuit of an electromagnetic device. In this specification, the non-magnetic member is a member for electromagnetic field that comprises a non-magnetic titanium alloy and is used in an alternating magnetic field. This non-magnetic member is not necessarily wholly made of a titanium alloy, and is not necessarily wholly non-magnetic. That is, at least part of the non-magnetic member according to the embodiment of the present disclosure needs to be made of titanium alloy.

(2) Unless otherwise specified, a numerical range of “x-y” as tolerance mentioned in the present specification includes a lower limit value “x” and an upper limit value “y”. Within the numerical range of “x-y”, another numerical range of “a-b”, including another lower limit value “a” and another upper limit value “b” may be newly established as mentioned in the present specification. Further, a numerical range such as “x-y μΩm” means “x μΩm to y μΩm unless otherwise specified. The same applies to other unit systems, such as MPa and GPa.

One or more components arbitrarily selected from the present specification may be added to the above-described components of the present disclosure. The contents described in the present specification are not limited to the non-magnetic member, but may be appropriately applied to its production method. The component elements may be applied to both of the device and the method. The best embodiment is determined based on the intended application, required performance, and the like.

TABLE 1

| | | | | | | | | | CHARACTERISTIC PROPERTY OF Ti ALLOY |
|---|---|---|---|---|---|---|---|---|---|
| | COMPOSITION OF RAW MATERIAL POWDER | | | | | | | | ELEC. |
| | GROSS COMPOSITION | | | | | | | | PROPERTY |
| SMP | (MASS %/Ti) | | | | | | | | SPEC. ELEC. R |
| No | Al | V | Fe | Mo | Mn | S | Al EQ. | Mo EQ. | (μΩm) |
| 1 | 8.6 | 5.7 | 1.2 | 1.8 | 0.63 | 0.37 | 8.6 | 9.7 | 2.4 |
| 2 | 8.6 | 5.7 | 1.6 | 2.4 | 0.63 | 0.37 | 8.6 | 11.2 | 2.4 |
| 3 | 8 | — | 2 | 3 | 0.63 | 0.37 | 8 | 9 | 2.4 |
| 4 | 8.6 | 5.7 | 0.8 | 1.2 | 0.63 | 0.37 | 8.6 | 8 | 2.4 |
| 5 | 6.5 | — | 2.86 | 3.3 | 2.34 | — | 6.5 | 14.7 | 2.4 |

| C1 | 6 | 4 | — | — | — | 6 | 2.7 | 1.7 |
|---|---|---|---|---|---|---|---|---|
| C2 | 9 | 6 | — | — | | 9 | 4 | 2.0 |
| C3 | 6 | — | 1.2 | 1.8 | | 6 | 4.8 | 2.3 |
| C4 | 4.5 | 3 | 2 | 2 | | 4.5 | 9 | 1.2 |
| C5 | 5 | — | 2 | 3 | | 5 | 8 | 1.2 |

| | CHARACTERISTIC PROPERTY OF Ti ALLOY | | | | | |
|---|---|---|---|---|---|---|
| | MECHANICAL PROPERTY | | | | RATIO OF | |
| | YOUNG’S | | 0.2% PROOF | | ISLAND | |
| SMP | MODULUS | TS | STRESS | ELONGATION | STRUCTURE | |
| No | (GPa) | (MPa) | (MPa) | (%) | (Vol %) | NOTE |
| 1 | 121 | 1400 | 1388 | 1 | 55 | |
| 2 | 118 | 1496 | 1490 | 0.5 | 50 | |
| 3 | 127 | 1296 | 1291 | 0.5 | 45 | |
| 4 | 119 | 1365 | 1287 | 1 | 40 | |
| 5 | 113 | 1623 | 1520 | 1 | 65 | |
| C1 | 117 | 1050 | 995 | 7 | 0 | |
| C2 | 118 | 1110 | 1010 | 0.1 | 0 | |
| C3 | 122 | 1165 | 1003 | 6 | 0 | |
| C4 | 115 | 1200 | 950 | 10 | 0 | COMMERCIAL |
| C5 | 120 | 1400 | 1050 | 8 | 0 | |

What is claimed is:

1. A non-magnetic member used in an alternating magnetic field, the non-magnetic member comprising:
a titanium alloy comprising an alpha stabilizer in which an aluminum equivalent is 5.5-11.0 by mass fraction to the total mass of the titanium alloy and a beta stabilizer in which a molybdenum equivalent is 6.0-17.0 by mass fraction to the total mass of the titanium alloy, wherein
the beta stabilizer comprises iron and manganese.

2. The non-magnetic member according to claim 1, wherein the manganese accounts for 0.2-3.0% of the whole titanium alloy by mass fraction.

3. The non-magnetic member according to claim 1, wherein the titanium alloy further comprises sulfur that accounts for 0.1-1.0% of the whole titanium alloy by mass fraction.

4. The non-magnetic member according to claim 1, wherein the titanium alloy consists of a complex structure where hexagonal close-packed lattice structures are distributed like islands in a body centered cubic lattice structure.

5. The non-magnetic member according to claim 4, wherein the hexagonal close-packed lattice structures account for 30-70 vol % of the whole complex structure.

6. The non-magnetic member according to claim 1, wherein the titanium alloy has a specific electrical resistance of 2 μΩm or more.

7. The non-magnetic member according to claim 1, wherein the titanium alloy has a 0.2% proof stress of 1150 MPa or more.

8. The non-magnetic member according to claim 1, wherein the titanium alloy consists of a sintered material.

9. A method for producing the non-magnetic member according to claim 8, the method comprising:
sintering a powder to produce a sintered body; and
forming the sintered body into a shape desired for the non-magnetic member, wherein
after the forming step, the titanium alloy is produced without solution treatment.

10. The method for producing the non-magnetic member according to claim 9, wherein the powder at lease comprises a ferromolybdenum powder and a manganese sulfide powder.
